(19) United States
(12) Patent Application Publication
(10) Pub. No.: US 2016/0372243 A1
(43) Pub. Date: Dec. 22, 2016

(54) Anisotropic Rare Earths-Free Matrix-Bonded High-Performance Permanent Magnet Having A Nanocrystalline Structure, And Method For Production Thereof

(71) Applicant: Siemens Aktiengesellschaft, München (DE)

(72) Inventors: Caroline CASSIGNOL, Muenchen (DE); Michael KRISPIN, Vaterstetten (DE); Inga ZINS, Muenchen (DE)

(73) Assignee: SIEMENS AKTIENGESELLSCHAFT, Muenchen (DE)

(21) Appl. No.: 14/901,792

(22) PCT Filed: May 26, 2014
(86) PCT No.: PCT/EP2014/060778

§ 371 Date: Dec. 29, 2015

(30) Foreign Application Priority Data
Jul. 12, 2013 (DE) 10 2013 213 646.3

(51) Int. Cl. H01F 1/06; H01F 1/08; H01F 41/02

(52) U.S. Cl. CPC H01F 1/061; H01F 41/0273; H01F 1/083

(57) ABSTRACT

A method for producing a permanent magnet includes coating synthesized nanoparticles with a matrix by a by physical or physical-chemical deposition process, and introducing the matrix-coated nanoparticles into a mold, and exposing the matrix-coated nanoparticles in the mold to an external force field. High fill levels can be achieved in this manner.

### CROSS-REFERENCE TO RELATED APPLICATIONS

This application is a U.S. National Stage Application of International Application No. PCT/EP2014/060778 filed May 26, 2014, which designates the United States of America, and claims priority to DE Application No. 10 2013 213 646.3 filed Jul. 12, 2013, the contents of which are hereby incorporated by reference in their entirety.

### TECHNICAL FIELD

The invention relates to a method according to the main claim and to a corresponding product.

### BACKGROUND

Because of supply risks and high prices for the rare earths, new, rare-earth-free solutions are being sought for the production of permanent magnets. Rare earths are used especially for the production of permanent magnets. Conventional rare-earth-free permanent magnet materials exhibit an energy density which is too low for high-tech applications—using iron, cobalt, nickel, or ferrites, for example—and/or are too expensive from an economic aspect, as is the case for FePt, for example.

The permanent-magnetic properties of magnetic materials are critically determined, in addition to the alloy composition, by the microstructure. In accordance with the theory of micro-magnetics, and also on the basis of experimental findings, it is known that a microstructural construction comprising single-domain, nanoscale structures can be used to obtain high coercive field strengths. This allows the construction of a rare-earth-free, high-performance magnet from nanoscale magnet building blocks. New nanotechnological synthesis methods are enabling the production of monocrystalline, single-domain, magnetic nanoparticles featuring a combination of shape anisotropy and crystalline anisotropy. For the construction of a macroscopic magnet, the magnetic nanoparticles must be embedded in organic or inorganic insulating matrices, in order not only to protect them from environmental effects and resultant corrosion processes but also to produce permanent magnets having appropriate mechanical, electrical, and thermal properties. In particular, a high electrical resistance is advantageous in order to reduce eddy currents. The resultant high-performance magnets can be put to use advantageously in high-efficiency drives and generators.

For production of these magnetically and electrically optimized volume magnets, there are a host of criteria that must be met.

Conventional permanent magnets are produced, for example, by means of a sintering technique (1) or by plastics binding (2).

The conventional method of the sintering technique allows production of anisotropic magnets by alignment of powder particles in the magnetic field ahead of a pressing and sintering process. For the rare-earth-based magnets produced accordingly, the coercive field strength is limited because of the microcrystalline particle size, which is in the range of a few μm, and must be compensated by the addition to the alloy of very expensive and scarce heavy rare earth metals such as Dy or Tb. Owing to the unfavorable temperature coefficient of the coercive field, this fraction must additionally be increased in line with increasing operating temperature. The heating of the magnet as a consequence of eddy current losses, accordingly, requires the use of a substantial fraction of expensive heavy rare earth metals. Alternatively to this so-called sintered magnet, plastics-bound magnets as well are conventionally produced. For this purpose, magnetic particles based on rare earths and with a size of several tens to several hundreds of micrometers are embedded into a thermoset or thermoplastic matrix. The mixture generated in this procedure, which may also be called a compound, is composed of a maximally high fraction of magnetic particles and the matrix. The mixture is subsequently processed to a volume magnet by injection molding, allowing a magnetic fraction of up to 60 vol %, or by compression molding, allowing up to an 80 vol % magnetic fraction. In comparison to the above-described sintered magnets, the magnetic energy density of plastics-bound magnets is reduced as a result of the dilution effect of the matrix used.

For the production of nanocomposite formulations, which may also be termed compounds, by the embedding of nanoparticles into a matrix, the degrees of filling conventionally required are not high. On account of the difficulty in processing, on the contrary, the conventional attempt is to achieve the maximum effect with the minimum amount of nanoparticles. Conventionally, for example, a degree of filling of up to 15 vol% is achieved for carbon nanotubes or SiO₂ nanoparticles in an organic matrix. Given that high-performance permanent magnets require high degrees of filling, the use of such conventional standard methods is not conducive for nanoparticle-based magnets.

WO 2013/010173 A1 discloses a nanostructured magnetic alloy composition which is used for producing magnetic nanocomposite material for permanent magnets for electromechanical and electronic devices, and features an iron-nickel alloy.

CN 102610346A discloses a rare-earth-free, nanocomposite permanent-magnetic material that features a permanent-magnetic phase generating alloys with manganese, aluminum, bismuth, and aluminum, and an alpha-iron-generating soft-magnetic phase.

### SUMMARY

One embodiment provides a method for producing a permanent magnet (PM), comprising the steps of synthesizing rare-earth-free ferromagnetic anisotropic nanoparticles; coating the synthesized nanoparticles with a matrix via physical or physicochemical deposition, and generating a matrix coating of the nanoparticles; introducing the matrix-coated nanoparticles into a mold, and applying an external force field to orient and shape the matrix-coated nanoparticles.

In a further embodiment, the deposition takes place by means of physical vapor deposition, chemical vapor deposition, or thermal spraying, more particularly ion beam-assisted deposition or sputtering, molecular beam epitaxy, electron beam evaporation, atomic layer deposition, or laser ablation.

In a further embodiment, the matrix consists of organic material, more particularly of a plastic.

In a further embodiment, the plastic is a thermoplastic or a thermoset.

In a further embodiment, the plastic is polyphenyl sulfide or polyamide or epoxide.

In a further embodiment, the method includes synthesizing of ferromagnetic anisotropic nanoparticles.

In a further embodiment, the nanoparticles have a core or a core-shell construction, the shell completely or partly covering the core.

In a further embodiment, the nanoparticles have a protective casing.

In a further embodiment, during the coating of the synthesized nanoparticles, they are distributed spatially by means of a distributing device, more particularly a fluidized bed.

In a further embodiment, after they have been coated, the synthesized nanoparticles are in powder form.

In a further embodiment, the orienting and shaping are performed simultaneously.

In a further embodiment, the matrix coating solidifies or cures during or after shaping.

In a further embodiment, the solidifying or curing is activated, more particularly thermally activated.

In a further embodiment, the nanoparticles contain Co, Fe, Ni, or Mn and/or are synthesized wet-chemically.

In a further embodiment, the core consists of a soft-magnetic material and the shell of a hard-magnetic material or the construction is the other way round.

In a further embodiment, the protective casing consists of carbon and has been generated by storage of the nanoparticles for a period of several hours and temperatures in the region of around 250° C. to 350° C. in an organic liquid.

In a further embodiment, the protective casing consists of silicon dioxide and has been generated by hydrolysis and polycondensation of silane compounds in a polar solvent.

Another embodiment provides a permanent magnet formed by any of the methods disclosed above.

### BRIEF DESCRIPTION OF THE DRAWINGS

Embodiments of the invention are described in more detail below with reference to the figures, in which:

FIG. 1 shows a first exemplary embodiment of nanoscale magnet building blocks used in accordance with the invention;

FIG. 2 shows a second exemplary embodiment of nanoscale magnet building blocks used in accordance with the invention;

FIG. 3 shows an exemplary embodiment of a method of the invention;

FIG. 4 shows a further exemplary embodiment of a method of the invention; and

FIG. 5 shows an exemplary embodiment of a permanent magnet of the invention.

### DETAILED DESCRIPTION

Embodiments of the invention can produce, reliably and simply, highly active permanent magnets having a nanocrystalline structure. The intention in particular is to be able to produce magnetically and electrically optimized volume magnets which meet in particular the following criteria: a high degree of filling, homogeneous particle distribution with parallel alignment along the magnetic axis, positionally fixed binding of the magnetic particles after alignment, and also magnetic and electrical decoupling. A production regime is intended in particular to overcome a high surface-to-volume ratio on the part of nanoparticles.

According to a first aspect, a method is proposed for producing a permanent magnet, comprising the following steps: synthesizing rare-earth-free ferromagnetic anisotropic nanoparticles; coating the synthesized nanoparticles, implemented by means of physical or physicochemical deposition, with a matrix; orienting and shaping the matrix-coated nanoparticles introduced into an external magnetic field and into a mold.

According to a second aspect, a permanent magnet is claimed which has been generated by means of a method according to the main claim.

Ferromagnetic means, in particular, exhibiting a very high permeability number and a positive magnetic susceptibility, and considerably strengthening a magnetic field.

Anisotropic means, in particular, having a directionally dependent property, more particularly a magnetic property.

Nanoparticles have dimensions which are nanoscale and here in particular compel a single-domain behavior, and are mono-crystalline.

The invention involves the construction of a rare-earth-free permanent magnet whose magnetic properties, as for example the magnetization, the coercive force, and the energy product, exceed the properties of conventional rare-earth-free permanent magnets. The improvement of the magnetic properties of the rare-earth-free magnets proposed herewith allows the replacement of conventionally used, rare-earth-based permanent magnets in electric motors and generators. For this purpose, the magnet is constructed from nanoscale, single-domain particles, which may also be referred to as nanoparticles. This magnetically optimized microstructure maximizes the attainable coercive field and also allows great magnetization by means of a suitable selection of material. An advantageously thin matrix layer is deposited on the magnetic nanoparticles. The thickness of the matrix layer is located more particularly in the nanometer range.

Further embodiments are claimed in connection with the dependent claims.

According to one embodiment, the deposition of a matrix may take place by means of laser ablation, atomic layer deposition, chemical vapor deposition, ion beam-assisted deposition, molecular beam epitaxy, or electron beam evaporation, as for example by deposition by means of physical vapor deposition, more particularly laser ablation, ion beam-assisted deposition (also sputtering), molecular beam epitaxy, electron beam evaporation, chemical vapor deposition, more particularly atomic layer deposition, plasma-assisted deposition, at atmospheric pressure or low pressure, or thermal spraying.

According to another embodiment, the matrix may consist of organic material, more particularly of a plastic.

According to another embodiment, the plastic may be a thermoplastic or a thermoset.

According to another embodiment, the plastic may be polyphenyl sulfide, a polyamide, or an epoxide.

According to another embodiment, ferromagnetic anisotropic nanoparticles can easily be industrially synthesized. Anisotropy is relative in particular to the shape or to the crystal structure.

According to another embodiment, the nanoparticles may have a core or a core/shell construction and optionally cumulatively a protective casing. The shell may be soft-magnetic. The extremely thin protective casing, extending in particular in the nanometer range, protects the nanoparticles from corrosion and oxidation. The casing also reduces the agglomeration of the individual particles, thereby on the one hand reducing inter-particle contact which is unfavorable for the coercive field, and on the other hand increasing the anisotropy achievable by the volume magnet. The protective casing may consist, for example, of C and/or SiO₂.

According to another embodiment, during the coating of the synthesized nanoparticles, they can be distributed spatially by means of a distributing device, more particularly a fluidized bed.

According to another embodiment, the synthesized nanoparticles, after having been coated, may be in powder form.

According to another embodiment, the orienting and shaping may be performed simultaneously.

According to another embodiment, the matrix coatings may solidify or cure, or form a crosslinked or polymerized matrix coating, during or after shaping.

According to another embodiment, the solidifying or curing may be activated, more particularly thermally activated.

Chemical activation using catalysts is also possible.

According to another embodiment, the nanoparticles may contain Co, Fe, Ni, or Mn. The nanoparticles may be synthesized wet-chemically, from the gas phase, or by means of milling.

According to another embodiment, the core may consist of a soft-magnetic material and the shell of a hard-magnetic material, or may be formed the other way round.

According to another embodiment, the protective layer may consist of carbon and may have been generated by storage of the nanoparticles for a period of several hours and temperatures in the region of about 250° C. to 350° C. in an organic liquid.

According to another embodiment, the protective layer may consist of silicon dioxide and may have been generated by hydrolysis and polycondensation of silane compounds in a polar solvent.

According to other embodiments, the scope of protection of this application embraces all permanent magnets generated by means of a method in accordance with the present invention.

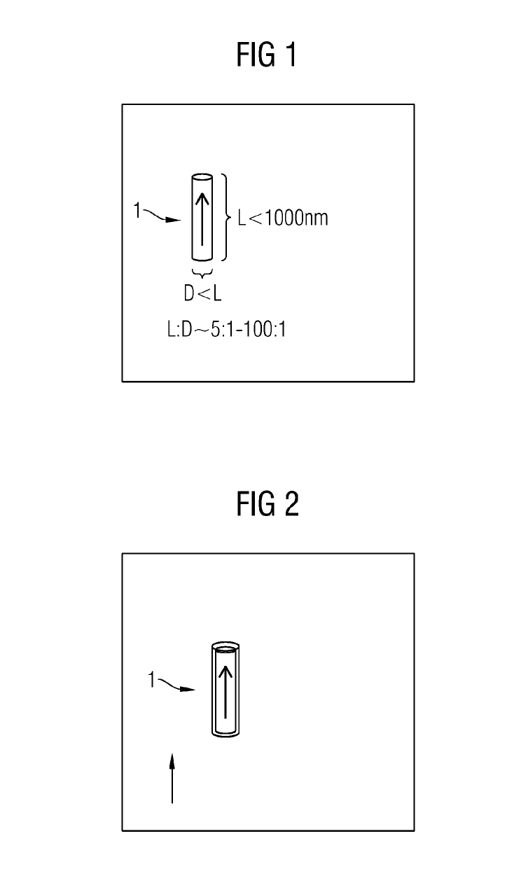

FIG. 1 shows an exemplary embodiment of nanoscale magnet building blocks 1 used in accordance with the invention. Permanent magnet properties are promoted in accordance with the invention by a structural construction in the form of nanoscale, single-domain particles featuring a combination of shape anisotropy and crystalline anisotropy. For this reason, by means of suitable synthesis methods, wet-chemical synthesis methods for example, ferromagnetic anisotropic nanoparticles 1 are synthesized which have high magnetization and coercive field strength. These particles may for example be Co, Fe, Ni, Mn-based. Also possible is a core/shell structure, in which case a core may consist of a soft-magnetic material and a shell may consist of a hard-magnetic material. Formation the other way round is also possible. FIG. 1 shows a length L of nanoparticles <1000 nm, with a thickness D being less than the length L, and the ratio L:D being situated approximately between 5:1 to 100:1. The arrow within the magnet building block marks a preferential magnetic direction.

FIG. 2 shows another exemplary embodiment of nanoscale magnet building blocks, or nanoparticles 1, used in accordance with the invention. According to this embodiment, each nanoparticle is additionally surrounded with, or has an additional surrounding of, a thin, nanoscale protective casing. The protective casing is shown as a sharp outline around an individual magnet building block. A preferential magnetic direction is again indicated by an arrow in the magnet building block. As a first protection against environmental effects and/or as protection from corrosion, these nanoscale magnet building blocks or nanoparticles 1 may be provided with a thin protective layer of, for example, carbon or silica. For this purpose, these nanoscale magnet building blocks, for example, are each either coated with carbon by storage for several hours at a high temperature, as for example at temperatures between 250° C. and 350° C., in an organic liquid, or coated with SiO₂ by hydrolysis and polycondensation of silane compounds in a polar solvent. Silane compounds may be, for example, aminopropylsilane (APS) or tetraethyl orthosilicate (TEOS). As well as the protective function with respect to environmental effects, in accordance with FIG. 2, a casing in accordance with FIG. 1 suppresses the formation of agglomerates, by reducing the strength of a magnetic interaction. The formation of agglomerates has an adverse effect on the attainable magnetic properties.

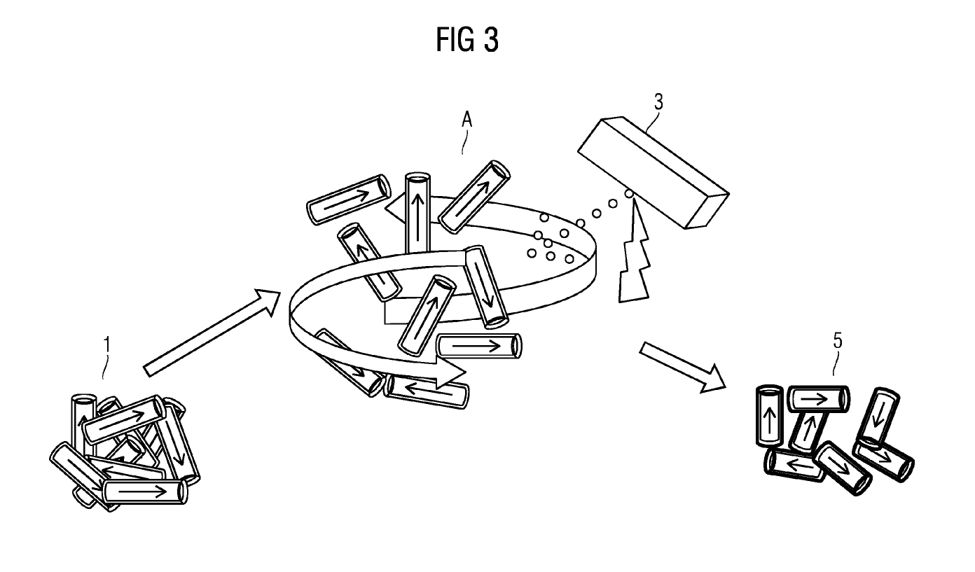

FIG. 3 shows an exemplary embodiment of a method of the invention. FIG. 3 shows a method for coating the magnet building blocks according to FIG. 1 or FIG. 2 with a matrix which consists in particular of plastic. In accordance with the invention it has been recognized that, for the production of volume magnets from nanoparticles 1 featuring a protective casing, sintering methods conventionally used with rare-earth-based magnets are unsuitable, since the high thermal energy input destroys the nanoscale structure. In accordance with the invention, further processing by embedment into a matrix 3 at suitable temperatures is proposed. For this purpose, individualized magnet building blocks according to FIG. 1 or FIG. 2, which are nanoparticles 1, are coated with a matrix in a fluidized bed and processed further. In particular, nanoparticles 1 having a protective casing are subjected, preferably in an inert gas atmosphere, to coating with a suitable matrix, more particularly a thermoplastic matrix, by means of a physical or physicochemical deposition method A. Examples of suitable deposition methods A are laser ablation (PLD, LA), atomic layer deposition (ALD), chemical vapor deposition (CVD), ion beam-assisted deposition (sputtering), molecular beam epitaxy (MBE), or electron beam evaporation. Comparable methods are in principle also possible. For plastics-bound magnets, for example, polyphenylene sulfide (PPS) or polyamide (PA) matrices are used. For laser ablation, for example, a PPS or PA target may be selected, allowing the deposition in accordance with the invention of a very thin matrix layer, in the nanometer range, of the corresponding material on the surface of the nanoparticles or magnet building blocks. The degree of filling can be effectively increased in this way, since the degree of filling is in inverse proportion to the layer thickness. In order to bring about homogeneous coating, it is particularly advantageous if the magnetic nanoparticles 1 are in finely distributed form during the method or the procedure. This fine distribution can be realized by means of a fluidized bed, for example. After the coating operation, a powder of individualized, matrix-coated, magnetic nanoparticles 5 is obtained. The magnet building blocks according to FIG. 1 or FIG. 2 are clad in the matrix 3 and can now be referred to as a compound. According to FIG. 3, the nanoscale magnet building blocks or nanoscale magnetic particles or nanoparticles 1 are coated with a matrix material 3, giving the nanoparticles 5 produced a full cladding of a thin matrix layer.

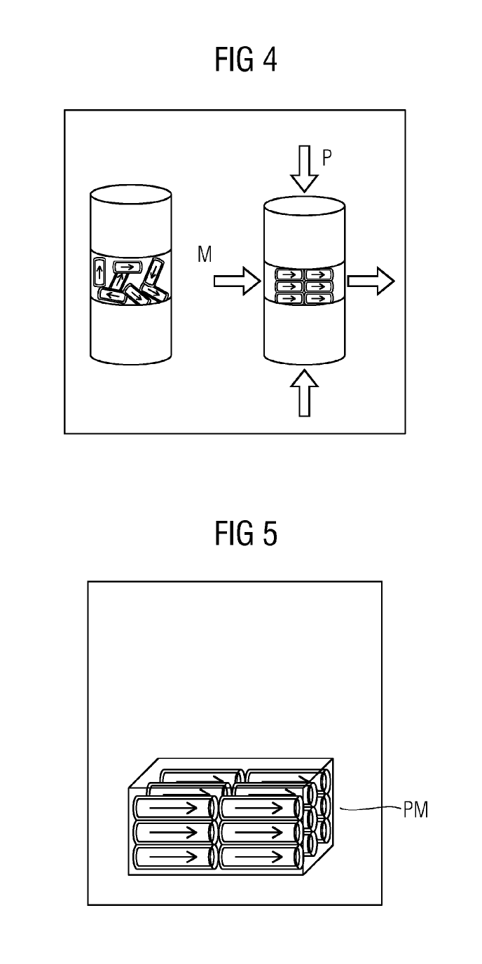

FIG. 4 shows further steps in a method of the invention. After the coating operation according to FIG. 3, the powder, consisting of matrix-coated, magnetic nanoparticles 5, is transferred into a mold, which is shown on the left-hand side in FIG. 4, and, in accordance with the right-hand representation in FIG. 4, the powder is oriented and compressed under an external field M, a magnetic field for example, preferably transversely to a direction of compression with a pressure P. Pressures P used are situated within a range from several MPa to GPa. Simultaneously with the orienting and compressive shaping, or afterward, the solidification or curing of the matrix 3 is activated thermally or chemically. The products of these operations are volume specimens having a high degree of filling with oriented, homogeneously distributed magnetic nanoparticles in a matrix. The individual nanoscale magnet building blocks or nanoparticles 1 are oriented and compacted in the external magnetic field, preferably transversely to the direction of compression with a pressure P, before the matrix casings 3 or the matrix coating are or is crosslinked, with—for example—thermal activation. FIG. 4 shows compacting of the coated nanoparticles 5 in the magnetic field M in accordance with the invention. FIG. 4 shows concluding method steps for the generation of a volume magnet.

FIG. 5 shows an exemplary embodiment of a permanent magnet PM of the invention. FIG. 5 shows an anisotropic, plastics-bound volume magnet which consists of nanoscale magnet building blocks 1. The physical or physicochemical deposition methods A, claimed in accordance with the invention, for the coating and embedding of magnetic nanoparticles 1 into a matrix 3, with subsequent compaction and curing in the magnetic field M, leads to a maximum possible filling factor in conjunction with homogeneous distribution and almost complete orientation, in order to achieve optimum magnetic properties. This is in contrast with conventional methods for embedding nanostructures, which are optimized only to relatively low filling factors. Another advantage of the embedding according to the invention into a matrix 3 lies in the low processing temperature by comparison with conventional sintering methods. From the magnetic standpoint, accordingly, unfavorable particle growth is avoided in accordance with the invention. Moreover, a method of the invention permits near-net-shape manufacture. On account of the electrical insulating properties of the matrix material, the formation of eddy currents is suppressed in the case of use in alternating magnetic field, leading to an increase in temperature. The matrix coating takes on three functions: firstly, the joining of the individual nanomagnets or nanoparticles to form a volume magnet; secondly, the avoidance of direct contact of the individual nanomagnets—i.e., magnetic insulation is produced; and, thirdly, an electrical insulation for the purpose of suppressing eddy currents.

The invention relates to a method for producing a permanent magnet PM, by coating of synthesized nanoparticles 1 with a plastics-bound matrix 3, implemented by means of physical or physicochemical deposition A, and by orienting and shaping of the matrix-coated nanoparticles 5 introduced into an external magnetic field M and into a mold. High degrees of filling can be obtained in this way.

What is claimed is:

1. A method for producing a permanent magnet, comprising the steps of:
synthesizing rare-earth-free ferromagnetic anisotropic nanoparticles;
coating the synthesized nanoparticles with a matrix using a physical or physicochemical deposition to generate a matrix coating of the nanoparticles;
introducing the matrix-coated nanoparticles into a mold; and
applying an external force field to orient and compress the matrix-coated nanoparticles in the mold.

2. The method of claim 1, wherein the deposition comprises physical vapor deposition, chemical vapor deposition, or thermal spraying.

3. The method of claim 1, wherein the matrix consists of a plastic.

4. The method of claim 3, wherein the plastic comprises a thermoplastic or a thermoset.

5. The method of claim 3, wherein the plastic is polyphenyl sulfide or polyamide or epoxide.

6. (canceled)

7. The method of claim 1, wherein the nanoparticles have a core or a core-shell construction, wherein the shell completely or partly covers the core.

8. The method of claim 1, wherein the nanoparticles have a protective casing.

9. The method of claim 1, comprising, during the coating of the synthesized nanoparticles, using a fluidized bed to spatially distribute the nanoparticles.

10. The method of claim 1, wherein the synthesized nanoparticles are in powder form after being coated with the matrix.

11. The method of claim 1, wherein the steps of orienting and shaping the matrix-coated nanoparticles are performed simultaneously.

12. The method of claim 1, wherein the matrix coating solidifies or cures during or after shaping.

13. The method of claim 12, the solidifying or curing of the matrix coating comprises comprising a thermal activation.

14. The method of claim 1, wherein the nanoparticles at least one of (a) contain Co, Fe, Ni, or Mn or (b) are synthesized wet-chemically.

15. The method of claim 7, wherein the core consists of a soft-magnetic material and the shell of a hard-magnetic material, or vice versa.

16. The method of claim 7, wherein the protective casing consists of carbon and is generated by storage of the nanoparticles for a period of multiple hours and temperatures in a range of around 250° C. to 350° C. in an organic liquid.

17. The method of claim 7, wherein the protective casing consists of silicon dioxide and is generated by hydrolysis and polycondensation of silane compounds in a polar solvent.

18. A permanent magnet generated a process including:
synthesizing rare-earth-free ferromagnetic anisotropic nanoparticles;
coating the synthesized nanoparticles with a matrix using a physical or physicochemical deposition to generate a matrix coating of the nanoparticles;
introducing the matrix-coated nanoparticles into a mold; and
applying an external force field to orient and compress the matrix-coated nanoparticles in the mold.

19. The method of claim 1, wherein the deposition comprises ion beam-assisted deposition or sputtering, molecular beam epitaxy, electron beam evaporation, atomic layer deposition, or laser ablation.
